(19) United States
(12) Patent Application Publication
(10) Pub. No.: US 2007/0277721 A1
(43) Pub. Date: Dec. 6, 2007

(54) Watercraft steering and control apparatus with joystick

(76) Inventor: John Charles Crotts, Mt. Pleasant, SC (US)

Correspondence Address: KATHLEEN M HARLESTON;THE HARLESTON LAW FIRM, 909 TALL PINE ROAD, MT PLEASANT, SC, 29464, US

(21) Appl. No.: 11/444,760

(22) Filed: Jun. 1, 2006

(51) Int. Cl. G05D 1/02

(52) U.S. Cl. 114/144 R

(57) ABSTRACT

A steering and control apparatus for steering a waterjet propelled watercraft includes: (a) a joystick apparatus including a movable joystick and a mechanical housing supporting the joystick in the cockpit; (b) an outdrive at a rear of the watercraft including a movable rear nozzle, (c) a trim control push-pull cable operably connecting the joystick apparatus and the nozzle; (d) a left/right push-pull cable operably connecting the joystick apparatus and the nozzle; (e) a throttle trigger portion attached to the joystick apparatus; and (f) a forward/reverse push-pull cable linking the throttle trigger portion and the throttle. The steering and control apparatus preferably also includes: (g) a forward/reverse lever mechanism adjacent the joystick apparatus with a forward/reverse lever; and (h) a forward/reverse push-pull cable operably connecting the forward/reverse mechanism and a mechanism for diverting an outflow from the outdrive nozzle movably attached to the outdrive.

### BACKGROUND OF THE INVENTION

1. Technical Field

The present invention relates generally to an apparatus including a joystick, and at least three push-pull cables for steering a small watercraft having a jet drive engine and an outdrive.

2. Background Information

There are many different types of watercraft steering apparatus, each of which includes a steering device and a marine propulsion device. Examples of steering devices include rotary steering devices and tiller handles for rotating and holding outboard motors in different positions. Examples of marine propulsion devices include stem drives, outboard motors, shafted propellers, surface drives, and waterjets.

A waterjet is normally affixed to the bottom of boat's hull and rearwardly discharges a stream of high velocity water to impel a boat forward. Water, traveling at the speed of the boat, enters an intake and continues onto a pumping unit. Within the pumping unit, a spinning impeller, powered by the watercraft's engine, increases the pressure of the water. The water then exits the waterjet through a nozzle as a high velocity stream, which drives the boat forward. The direction of the high velocity water stream from the waterjet determines the direction of propulsion of the boat. A boat driver operates a rotary steering device or the like to manipulate the direction of the high velocity water stream.

A waterjet is in many ways superior to other types of marine propulsion devices. It imparts superior maneuverability to a boat, and is efficient and easy to install. Additionally, a waterjet has a simple design, low drag, and a shallow draft. It is easy to maintain, smooth and quiet, and does not endanger people in the water like an exposed propeller would. Lastly, a waterjet maximizes the life of an engine, since its impeller is matched to the boat's engine power, and the waterjet will not overload the boat's engine. A watercraft with a waterjet propulsion device is therefore highly desirable.

Unfortunately, rotary steering systems commonly used in waterjet propelled watercraft, such as leisure-type powerboats, typically have a steering column that extends between a steering wheel and a mechanical housing. Rotary steering systems typically have a completely enclosed mechanical housing, which cannot be readily opened for servicing. A need therefore exists for a steering system that is easy to service.

Like a steering wheel in an automobile, installing a steering wheel in a waterjet propelled watercraft is popular because it is generally intuitive to use. Although popular, steering wheels rely on converting rotational movement to linear movement. A waterjet requires application of a linear force and linear movement to effect steering. Devices for achieving this may be, for example, a rack and pinion drive. One of the disadvantages of having to convert rotary motion into linear motion is that the apparatus generally required for this purpose is relatively expensive to manufacture.

Another disadvantage relates to the steering rate, that is, the amount of turn of the waterjet for a given number of degrees of rotation of the steering wheel. A steering apparatus using a worm drive may require several revolutions of the steering wheel to provide a relatively short output movement, thus making it unsuitable for applications requiring fast steering response such as racing.

Yet another disadvantage of the conventional steering apparatus relates to its size and weight. Such systems are generally too heavy and bulky to be useful in, for example, a personal watercraft, which is generally smaller in size than larger capacity boats.

### BRIEF SUMMARY OF THE INVENTION

The present invention includes a steering and control apparatus for a small watercraft with a jet drive engine, comprising:

(a) a joystick apparatus comprising a movable joystick and a mechanical housing supporting the joystick in a cockpit of the watercraft;

(b) an outdrive at a rear (aft) of the watercraft, the outdrive comprising a movable rear nozzle,

(c) a trim control push-pull cable operably connecting the joystick apparatus and the movable nozzle;

(d) a left/right push-pull cable operably connecting the joystick apparatus and the movable nozzle;

(e) a throttle trigger portion attached to the joystick apparatus; and

(f) a forward/reverse push-pull cable linking the throttle trigger portion and a throttle of the watercraft. The steering and control apparatus preferably comprises: (g) a forward/reverse lever mechanism adjacent the joystick apparatus, the forward/reverse lever mechanism comprising a forward/reverse lever; and (h) a forward/reverse push-pull cable operably connecting the forward/reverse mechanism and a mechanism for diverting an outflow from the outdrive nozzle, the outflow diverting mechanism being movably attached to the outdrive.

The present invention provides a watercraft steering and control apparatus with a joystick and at least three push-pull cables for maneuvering a waterjet propulsion mechanism, which overcomes many of the problems of currently available rotary steering devices, and provides the public with a viable choice. The steering and control apparatus of the present invention is relatively small in size, light in weight, and relatively easy and inexpensive to manufacture. It is also very easy to adjust and service. It is responsive and reliable, and ideal for use over fresh or salt water. With this relatively simple steering and control apparatus, which is not hydraulic and does not require electricity, a small watercraft accommodating up to three people responds quickly to the driver's directions. The present steering and control apparatus is smooth and fluid. Only a simple apparatus is necessary for pulling the boat “out of the hole”, putting the boat on plane, and steering right and left, forward and rearward, in contrast with commonly available steering devices.

The present apparatus can be used with one hand, leaving the driver's other hand free to attend to other tasks. In a two seat small watercraft, the driver can sit in either seat, or between the two seats. A left or right handed driver can easily be accommodated. The joystick is positioned so that it is easy to grasp for long periods without strain on the driver's arm, and there is no steering wheel blocking the driver's line of sight. In short, this steering and control apparatus is quite responsive and a joy to use.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 shows a perspective view of a two-seat watercraft employing a steering and control apparatus according to the present invention;

FIG. 2 is an exploded perspective view of a watercraft steering and control apparatus according to the present invention;

FIG. 3A is a partial side cross-sectional view of the steering and control apparatus according to FIG. 2;

FIG. 3B is a side elevational view of an outdrive portion of the steering and control apparatus according to the present invention;

FIG. 4A is a partial side cross-sectional view of the steering and control apparatus according to FIG. 2;

FIG. 4B is a side elevational view of an outdrive portion of the watercraft steering and control apparatus according to the present invention, corresponding to FIG. 4A;

FIG. 5A is a partial side cross-sectional view of the steering and control apparatus according to FIG. 2;

FIG. 5B is a side elevational view of an outdrive portion of the watercraft steering and control apparatus according to the present invention, corresponding to FIG. 5A;

FIG. 6A is a partial front cross-sectional view of the steering and control apparatus according to FIG. 2;

FIG. 6B is a top plan view of an outdrive portion of the steering and control apparatus according to the present invention; and

FIG. 7 is a perspective view of a throttle portion of the steering and control apparatus according to the present invention.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

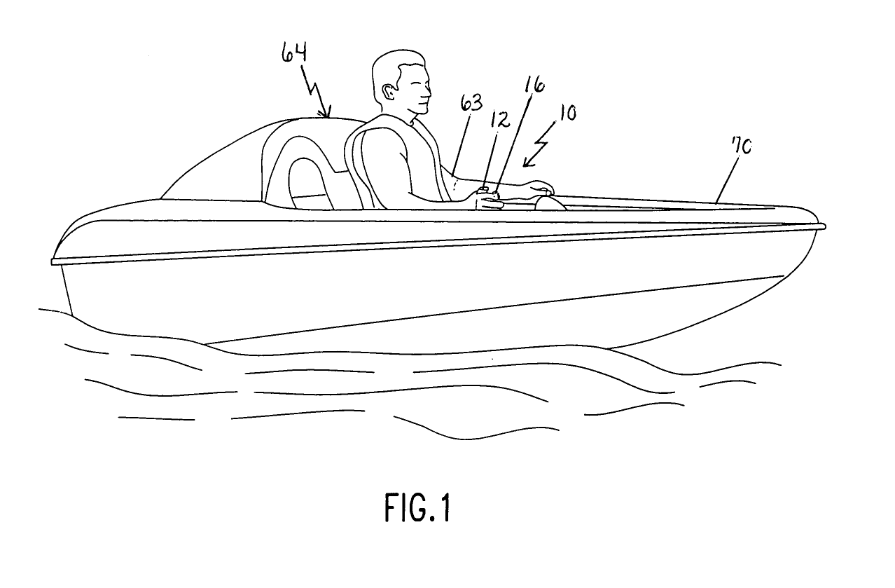

Referring to FIG. 1, the watercraft steering and control apparatus 10 of the present invention is for use on a small watercraft 70 driven by a marine jet engine. By “small watercraft” is meant a marine vessel less than about 18 feet in length or weighing less than about 1,000 pounds. The present invention is most preferably employed in a boat between about four and ten feet in length, and weighing about 500 pounds, which accommodates one, two, or possibly three people and has a waterjet propulsion mechanism. It is preferably a small boat 70 with a cockpit 64 having two side by side seats for the driver and, if desired, a passenger.

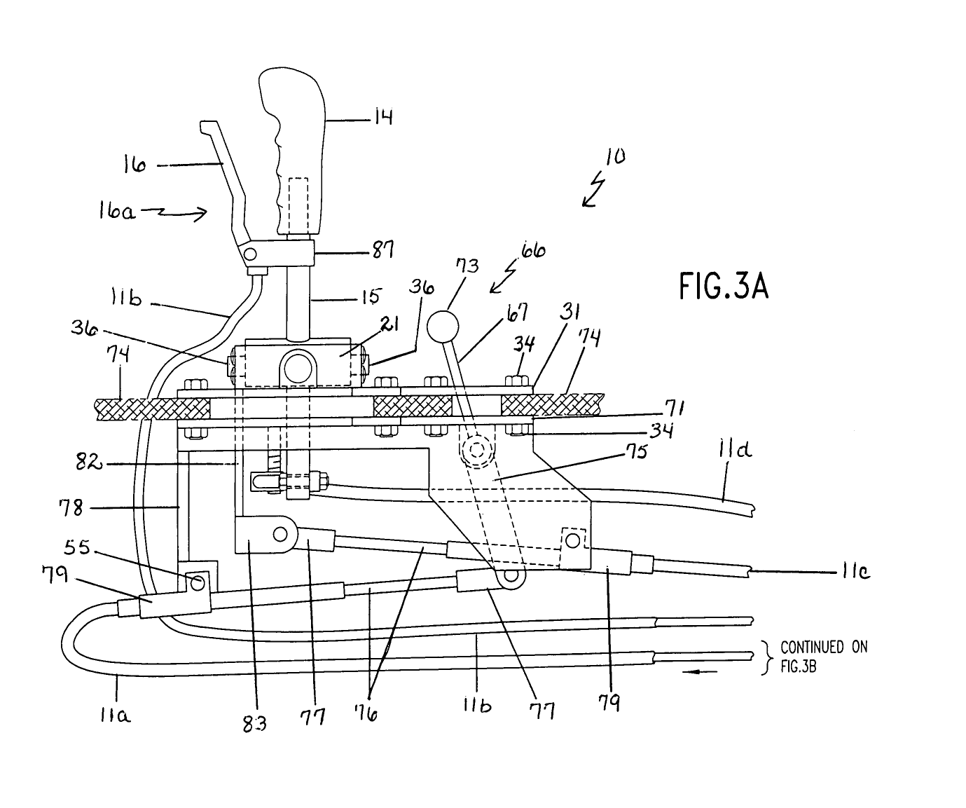

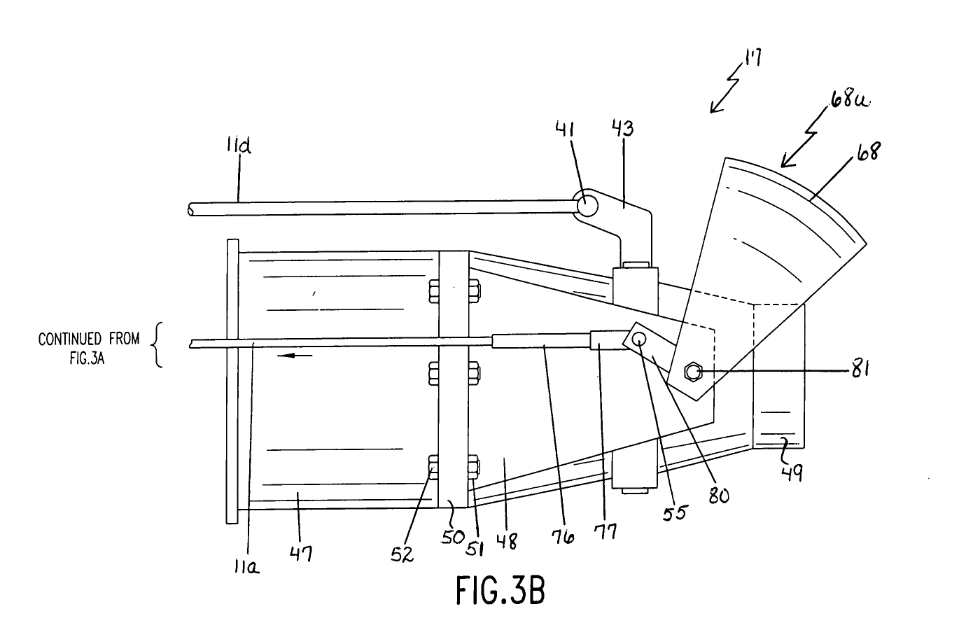

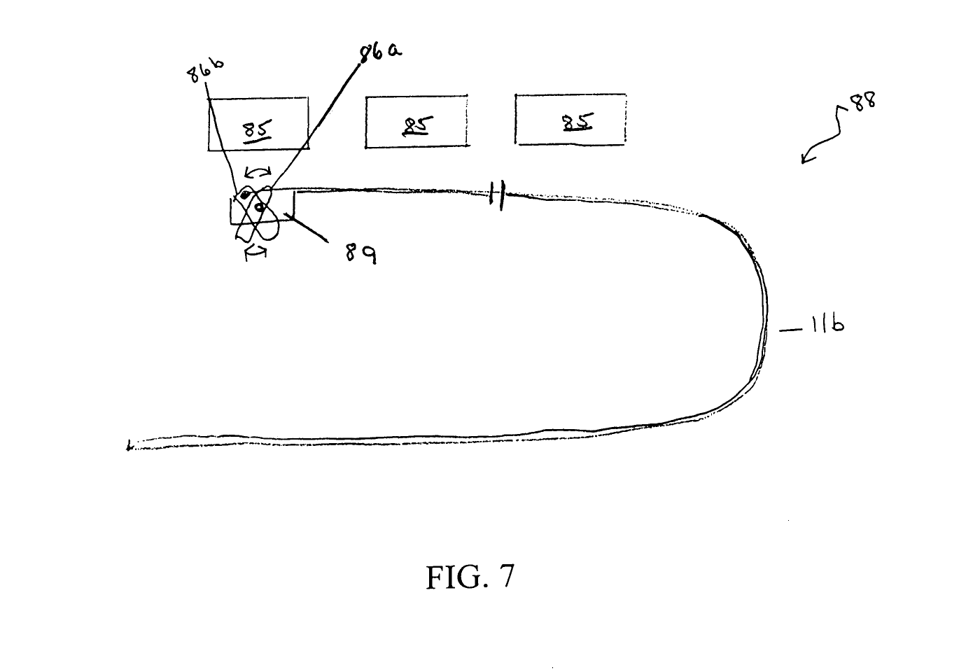

Referring to FIGS. 1, 2, and 3A, the steering and control apparatus 10 of the small watercraft 70 comprises at least three push-pull cables 11a, c, d, which enable the driver 63 of the watercraft 70 to steer the watercraft forward or in reverse (cable 11a) and in a left or right direction (cable 11c), and to trim (cable 11d) the watercraft. The steering and control apparatus 10 preferably also includes a fourth push-pull cable 11b, which enables the watercraft driver 63 to activate the throttle 65 (see FIGS. 3A and 7). The push-pull control cables can be of the same conventional construction as one another.

Push-pull cables are easy to use, durable, and reliable, even for use in salt water environments. They work smoothly and effectively year round. Each push-pull cable permits the transfer of linear motion from one end of the cable to the other. When an end rod on one end of the cable is depressed, the end rod at the other end of the push-pull cable moves a corresponding amount in the opposite direction. The end rod extends from a support tube. The inner operating member (not shown) of the push-pull cable is preferably made of stainless steel. The push-pull cable, which is internally lubricated during its manufacture, includes a plastic casement for protection. Any suitable type of push-pull cable may be used herein.

Referring to FIGS. 1 through 3B, the watercraft steering and control apparatus 10 includes:

(a) a joystick apparatus 12a comprising a movable joystick 12 and a mechanical housing 13 supporting the joystick 12 in a cockpit 64 of the watercraft 70;

(b) an outdrive 17 at a rear (aft) of the watercraft, the outdrive 17 comprising a movable rear nozzle 49,

(c) a trim control push-pull cable 11d operably connecting the joystick apparatus 12a and the movable nozzle 49;

(d) a left/right push-pull cable 11c operably connecting the joystick apparatus 12a and the movable nozzle 49;

(e) a throttle trigger portion 16a attached to the joystick apparatus 12a; and

(f) a forward/reverse push-pull cable 11b linking the throttle trigger portion 16a and a throttle 64 of an engine of the watercraft 88. The outflow diverting mechanism 68a is preferably a movable bucket 68. The steering and control apparatus preferably comprises: (g) a forward/reverse lever mechanism 66 adjacent the joystick apparatus 12a, the forward/reverse lever mechanism 66 comprising a forward/reverse lever 67; and (h) a forward/reverse push-pull cable 11a operably connecting the forward/reverse mechanism 66 and a mechanism for diverting an outflow from the outdrive nozzle 49.

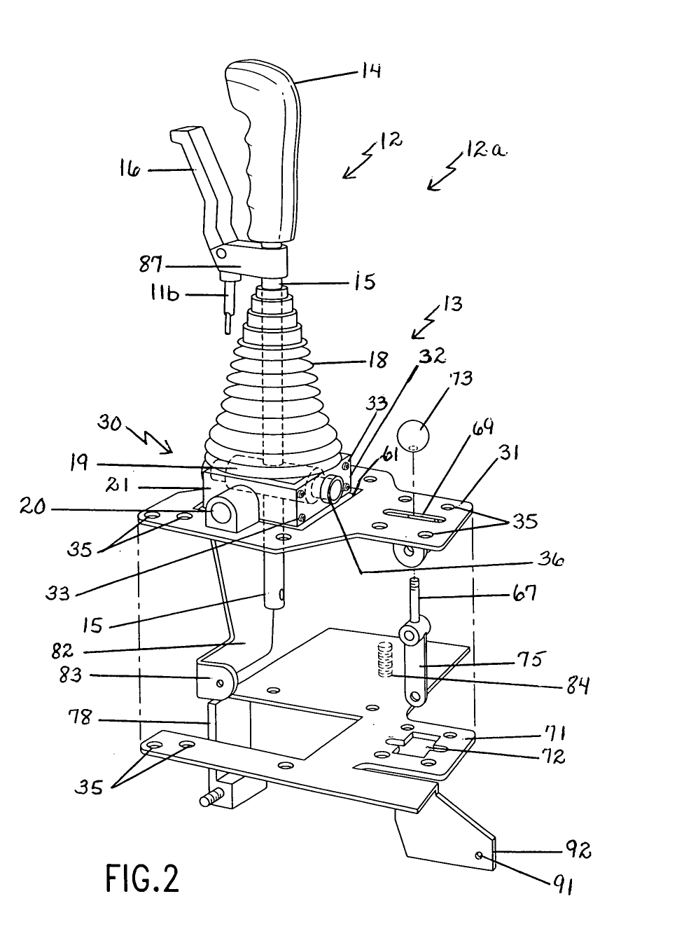

In regard to guiding the watercraft forward and in reverse in the preferred embodiment shown in FIGS. 2 and 3B, the watercraft steering and control apparatus 10 includes: the forward/reverse lever mechanism 66 adjacent the joystick apparatus 12a, and a forward/reverse push-pull cable 11a operably connecting the forward/reverse mechanism 66 and an outdrive bucket 68 or the like adjacent the outdrive nozzle 49 and movably attached to the outdrive 17 at the rear (aft) of the watercraft.

As seen in FIGS. 2 and 3A, the forward/reverse (“F/R”) lever mechanism 66 includes a forward/reverse lever 67, which is preferably located between the joystick lever 12 and the driver 63 so that it affords easy access to the driver. The length of the portion of the forward/reverse lever 67 that extends above deck level is preferably about one half to about one third the length of the portion of the joystick 12 that extends above the deck 74 of the watercraft 70. The driver can easily reach over the forward/reverse lever to grip the hand grip 14 of the joystick 12. The joystick lever 12 and forward/reverse lever 67 are preferably in the approximate center of the cockpit 64 between the two watercraft seats and a foot or two aft from the two seat backs), where the watercraft is a two seater.

In fact, with the present steering and control apparatus 10, the driver 63 can surprisingly sit in either seat of the watercraft. A left handed driver, then, could sit in the right hand seat (i.e., the seat to his right), if desired, where his or her left hand can comfortably rest on either lever. Any passenger can then sit next to the driver in the left hand seat. Conversely, a right handed driver would likely prefer to sit in the seat to his left, where his or her dominant right hand comfortably accesses the two levers, as shown in FIG. 1. Any passenger can then sit next to the driver in the right hand seat. If desired, a driver traveling alone can sit on portions of both seats with his or her legs straddling the joystick 12 and forward/reverse lever 67.

Both the joystick 12 and the forward/reverse lever 67 extend through a holes in an upper plate 31 and a lower plate 71, which help to support the joystick and the forward/reverse lever. The forward/reverse lever 67 extends through corresponding slotted holes 69, 72 in the generally horizontally extending upper plate 31, which is preferably attached to the top face of the deck 74 of the watercraft 70, and the generally horizontally extending lower plate 71, which is preferably attached to the bottom face of the deck 74. Specifically, the forward/reverse lever 67 extends through a forward/reverse lever slot 69 at the rear of the upper plate 31, through a hole in the deck 74 below the upper plate 31, and through a forward/reverse lever hole 72 in the lower plate 71 that is attached to the bottom of the deck (see FIG. 3A). As seen in FIGS. 2 and 3A, the upper plate 31 and the lower plate 71 are preferably attached to the deck 74 by means of a number of second bolts 34 extending through a number of bolt apertures 35 in the upper and lower plates 31, 71 and the deck 74. The upper and lower plates 31, 71 both extend in a generally horizontal direction, with the lower plate 71 extending beneath and generally parallel to the upper plate (see FIG. 3A).

As seen in FIGS. 1 and 3A, a threaded upper end portion of the forward/reverse lever 67 is preferably screwed into a correspondingly threaded hole in a lever ball 73. The lever ball 73 facilitates grasping and shifting the forward/reverse lever 67.

An opposite, lower end of the forward/reverse lever 67 is attached to a forward/reverse lever arm 75 of the forward/reverse lever mechanism 66, which is below the deck and lower plate 31 (i.e., below deck). An opposite, lower end of the forward/reverse lever arm 75 is movably attached to a slidable cable end rod 76 of the forward/reverse push-pull cable 11a via an end rod cable connector 77 on the cable end rod. Further along the forward/reverse push-pull cable 11a, a portion of the push-pull cable 11a is attached to a lower portion of a generally vertically extending bracket 78 extending below deck from the generally horizontal lower plate 71 via a bracket cable connector 79. The bracket cable connector 79 can pivot with movement in the watercraft, caused by, for example, wave motion, by means of a pivot pin 55 through the bracket cable connector 79. The generally vertically extending bracket 78 stabilizes the forward/reverse push-pull cable 11a.

Turning to FIG. 3B at the rear of the watercraft 70, the outdrive 17 supports a bucket 68 of the steering and control apparatus 10. The bucket 68 is movably connected to the outdrive structure and to the opposite end of the forward/reverse push-pull cable 11a via a bucket bracket 80 and a cable end rod connector 77. Specifically, one end of the cable end rod connector 77 is screwed onto the correspondingly threaded end of the cable end rod 76 at the opposite end of the forward/reverse push-pull cable 11a. An opposite end of the cable end rod connector 77 is attached to an end of the bucket bracket 80 with a pivot pin 55. An opposite end of the bucket bracket 80 is attached to the movable bucket 68 by a bucket bracket screw 81. A slidable plate or scoop or other structure that can be dropped down over the outdrive outflow and effectively divert the flow of water so that the watercraft moves rearwardly can be utilized in place of the bucket.

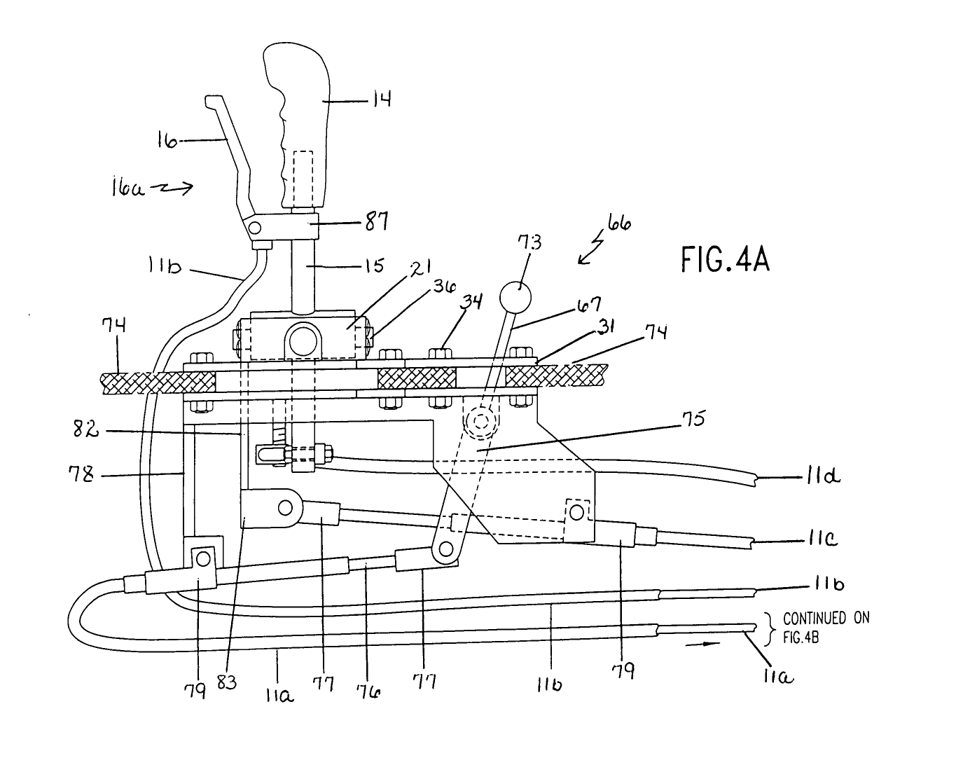

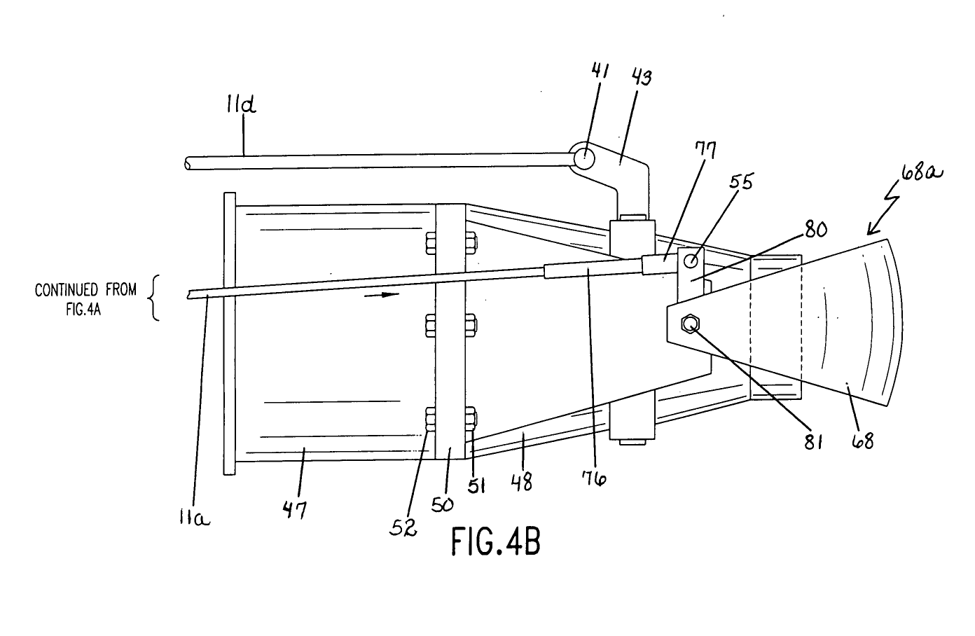

In use, the bucket 68 moves from an “up” position shown in FIG. 3B generally downward to a “down” position shown in FIG. 4B. When the watercraft engine is on and water is passing through the nozzle 49 of the outdrive 17, movement of the bucket 68 down in front of the nozzle as shown in FIG. 4B interrupts the outflow of water from the nozzle 49. The water outflow form the nozzle strikes the interior, scooped face of the bucket and is redirected. This allows the watercraft 70 to move in a reverse direction. Otherwise, when the bucket 68 is up and away from the nozzle 49, the outflow from the nozzle causes the watercraft 70 to move rapidly in a forward direction (see FIG. 3B).

In use, the bucket 68 is placed in the “up” position shown in FIG. 3B by the driver 63 pushing the forward/reverse lever 67 toward from the joystick 12 toward the front of the watercraft 70, as shown in FIG. 3A. The bucket 68 is placed in the “down” position shown in FIG. 4B by the driver 63 pulling the forward/reverse lever 67 away from the joystick 12 toward the rear of the watercraft 70, as shown in FIG. 4A. This is the “reverse” position of the forward/reverse lever 67. The length of the forward/reverse lever slot 69 in the upper plate 31 controls the distance that the forward/reverse lever 67 can be moved forward or back.

When the driver 63 pulls the forward/reverse lever 67 back into the reverse position as shown in FIG. 4A, the end of the forward/reverse lever arm 75 is pushed forward a corresponding distance toward the front of the watercraft 70. Since the forward/reverse lever arm 75 is connected to the cable end rod connector 77, this movement pushes in the end rod 76 of the forward/reverse push-pull cable 11a. Moving to FIG. 4B, pushing in the cable end rod 76 on one end of the forward/reverse push-pull cable 11a causes the end rod at the opposite end of the forward/reverse push-pull cable to push out. This pushes the end of the bucket bracket 80 up, which causes the bucket 68 to drop down in front of the nozzle as shown in FIG. 4B. This causes the watercraft 70 to move slowly in reverse (see above).

Turning to the joystick apparatus and steering the watercraft 70 to the left or right, movement of the joystick 12 to the driver's right or left when the watercraft engine is on and water is passing through the outdrive causes the outdrive nozzle 49 to move (preferably approximately a corresponding distance) in an opposite direction to the joystick direction of movement. The nozzle movement redirects the outdrive outflow, thereby causing the watercraft 70 to move to its left or right corresponding to the movement of the joystick 12. The watercraft driver 63 can thus quickly steer the watercraft 70 to his or her left or right by moving the joystick 12. As seen in FIGS. 2 and 3A, the joystick apparatus 12a comprises the joystick 12 and a mechanical housing 13 supporting the joystick 12. The joystick mechanical housing 13 is preferably made of rust-proof stainless steel.

As shown in FIGS. 2 and 3A, the generally elongate joystick 12 is comprised of a hand grip 14 connected to or around a top portion of a steering arm 15 of the joystick. In this preferred embodiment, a throttle trigger mechanism 16a is attached to the steering arm 15 just below (and adjacent) the hand grip 14. The steering and control apparatus 10 further includes the throttle trigger portion 16a. A throttle trigger 16 of the throttle trigger mechanism 16a extends in an upward direction adjacent the hand grip 14 to facilitate grasping by one or more fingers of the same hand that rests on the joystick hand grip 14. Preferably, the palm of the driver's hand rests on the joystick while one or more of the fingers of the same hand can be extended to grasp the throttle trigger. The hand grip 14 may be cushioned or molded, as shown in FIG. 2, to better fit a person's hand. The hand grip 14 of the joystick 12 preferably screws onto a correspondingly threaded end of the steering arm 15. The steering arm 15 extends through a conical rubber boot 18 into the mechanical housing 13. The bottom of the rubber boot 18 rests above the deck.

Continuing with FIGS. 2 and 3A, the bottom of the rubber boot 18 rests on a well 30 of the mechanical housing 13. The joystick steering arm 15 extends into and through the well 30. The well 30 is formed by the two opposite first sides 21 and the two opposite second sides 32 of the mechanical housing 13, which extend through a rectangularly shaped plate aperture 61 in the upper plate 31. The first sides 21 are substantially perpendicularly oriented to the second sides 32, so that the well 30 is generally rectangular in shape. (The word “rectangular” here is meant to include square.) The first and second sides 21, 32 are coupled together by any suitable means, for example by welding, riveting, or bolts. Preferably, the first and second sides 21, 32 are coupled by first bolts 33 inserted through holes in the sides 21, 32.

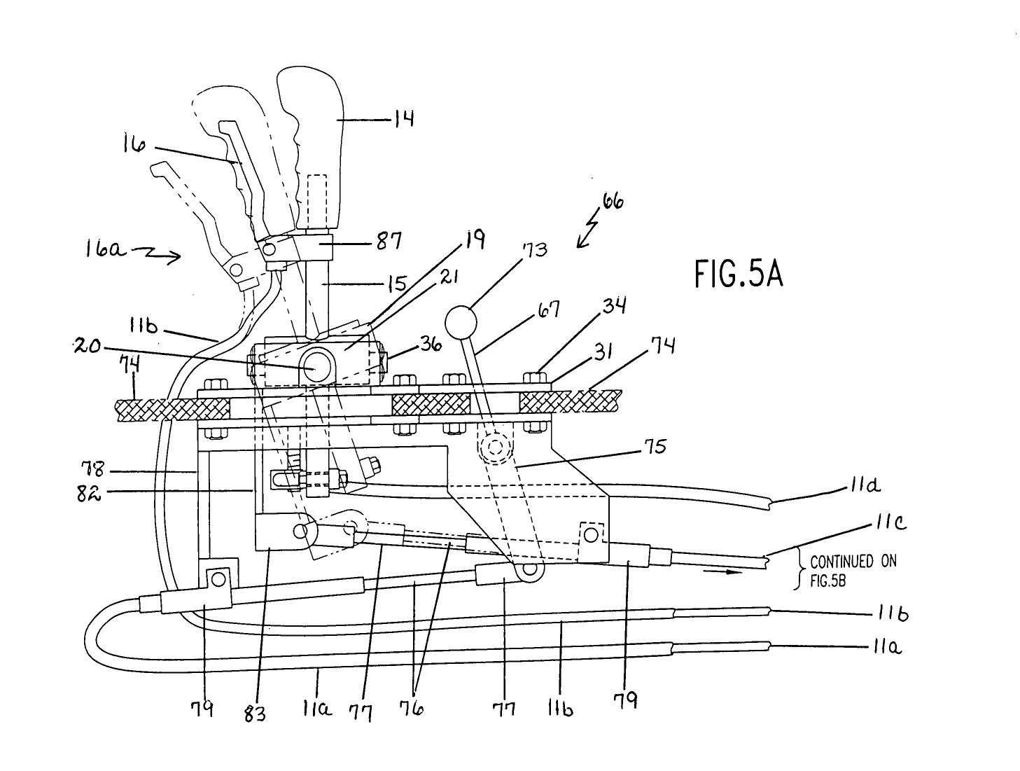

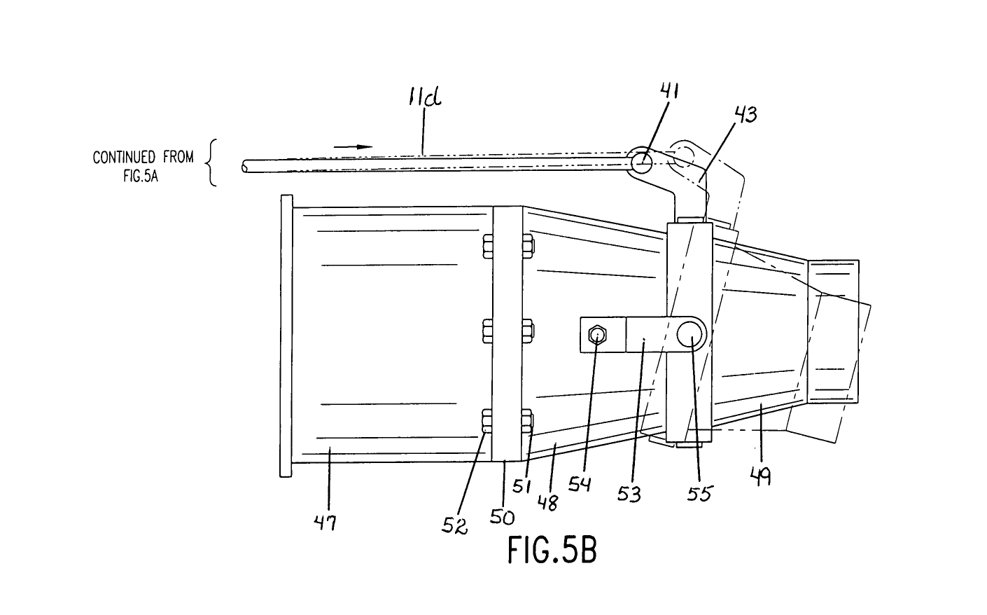

The upper plate 31, which is preferably made of stainless steel, is bolted to the watercraft deck by suitable means, such as second bolts 34 extending through bolt apertures 35 (see FIG. 5A, for example). The joystick steering arm 15 extends through the rectangularly shaped plate aperture 61 in the upper plate 31 and through a somewhat similarly shaped cutout in the lower plate 71 (see FIG. 2). A vertically directed mounting fin 90 extending out from the bottom of the generally horizontal lower plate 71 adjacent the forward/reverse lever hole 72 includes a fin hole 91 for attachment to any rigid connecting member (not shown) in the watercraft. This helps to stabilize the lower plate.

As depicted in FIGS. 2 and 3A, the generally vertically extending steering arm 15 extends generally perpendicularly through the center of a pivot joint 19. The pivot joint 19 is supported by the second sides 32 by means of one or two pivot casings 36 extending from the ends of the pivot joint 19 through holes in the second sides 32 (see FIG. 2). The pivot casing(s) 36 help to support the weight of the joystick 12. The pivot joint 19 and casing(s) 36 allow the joystick 12 to rock within the well 30. The joystick mechanical housing 13 “floats” within its plate aperture 61; the pivot joint 19 is only attached to the joystick steering arm 15.

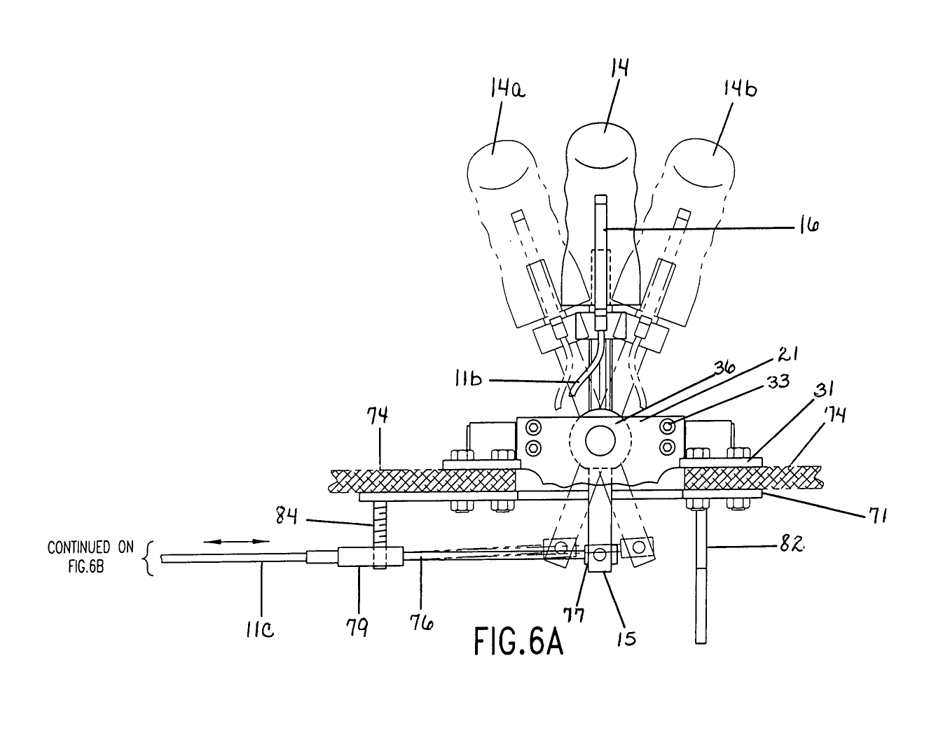

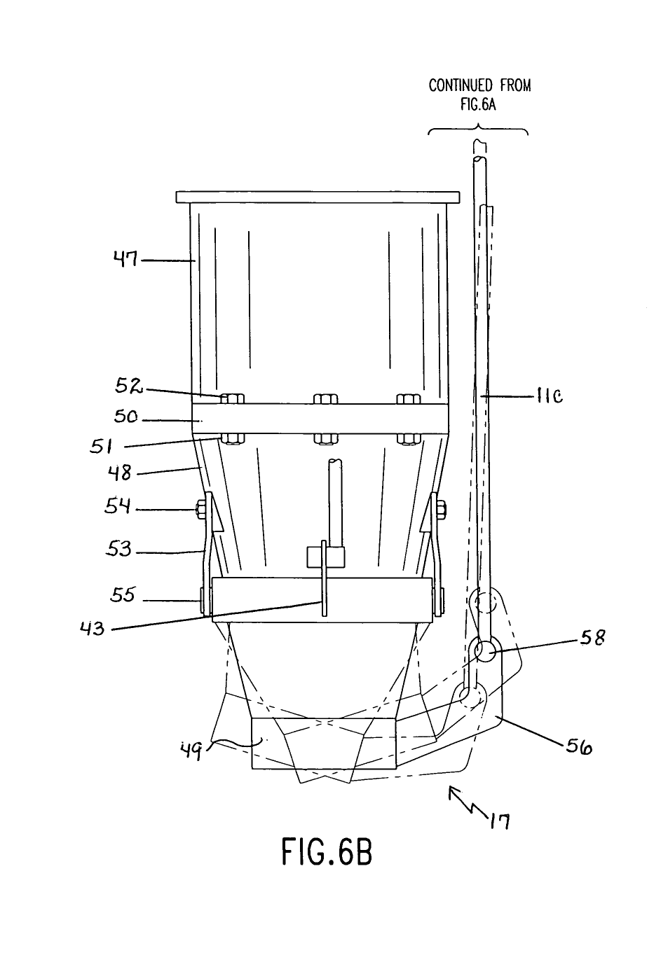

As seen in FIGS. 2, 3A, and 6A, a generally vertically extending left/right bracket 82 extending down below the deck 74 has a bracket portion 83 to which is attached a cable end rod connector 77. The cable end rod connector 77 is screwed onto the correspondingly threaded end of the slidable end rod 76 of the left/right push-pull cable 11c. As seen in FIG. 6A, a cable connector 79 further along the left/right push-pull cable 11c is attached to the lower plate 71 via a threaded pin 84 for stability.

Referring to FIGS. 5B and 6B, the outdrive 17 is comprised of an intake 47, a pumping unit 48, and a nozzle 49. The intake 47 is generally cylindrical in shape and hollow so that water may flow through it. Flanges 50, which extend generally outwardly from the back end of the intake 47 and the front end of the pumping unit 48, abut one another and are coupled together by a plurality of flange bolts 51 and flange nuts 52 to form a watertight seal between the intake 47 and the pumping unit 48. The pumping unit 48 is also generally cylindrical in shape and hollow; however, the pumping unit 48 is gradually tapered from its front end to its back end. The nozzle 49 is linked to the pumping unit 48 via outdrive brackets 53 (see FIG. 5B). Outdrive bracket screws 54 attach an end of each outdrive bracket 53 to a side of the pumping unit 48 and pivot pins 55 pivotally attach the opposite end of each outdrive bracket 53 to a side of the rear nozzle 49. The outdrive brackets 53 are located diametrically opposite to one another. The nozzle 49 is preferably generally cylindrical in shape, hollow, and gradually tapered from its front end to its back end. A first L-shaped arm 43 projects from the top side of the nozzle 49. The first L-shaped arm 43 permits trim control as described herein.

A second L-shaped arm 56 projects from a side of the nozzle 49. An impeller (not shown) powered by the watercraft engine spins within the pumping unit 48. In general, the impeller suctions water into the intake 47, increases the water's pressure, and discharges the high pressure water from the nozzle 49 to propel the boat forward.

Continuing with FIGS. 6A and 6B, the opposite end rod 76 of the left/right push-pull cable 11c is attached to the second L-shaped arm 56 via a second pin 58 in an aperture at an end of the second L-shaped arm 56. The L-shaped arm moves the outdrive nozzle 49 in a left or right direction. The joystick thus controls the orientation of the outdrive nozzle in a horizontal plane, thus allowing the driver to steer the watercraft left or right. In use, with the engine on and water flowing through the outdrive, the driver grasps the hand grip 14 of the joystick 12. When the driver moves the joystick 12 to his or her left, as indicated by 14b in FIG. 6A, the end rod 76 of the left/right push-pull cable 11c is pushed in. Turning to FIG. 6B, the end rod on the opposite end of the left/right push-pull cable 11c is therefore pushed out. This pushes the second L-shaped arm 56 away, which directs the nozzle 49, and therefore outflow from the nozzle, to the right. This causes the watercraft to move to the left. When the driver moves the joystick 12 to his or her right as indicated by 14a in FIG. 6A, the opposite occurs and the watercraft 70 moves to the right.

When the joystick 12 is in an upright, central position as seen in FIG. 6A, the rear nozzle 49 of the outdrive 17 is vertically aligned with the intake 47 and the pumping unit 48. Water is forced out of the rear nozzle 49 horizontally backward, which propels the nose of the boat horizontally forward.

In regard to trimming as shown in FIGS. 5A and 5B, movement of the joystick 12 forward away from the watercraft driver 63 and toward the front of the watercraft 70 permits the driver to trim the watercraft 70. The joystick 12 controls the orientation of the outdrive nozzle 49 in a vertical plane. When the watercraft driver 63 pushes the joystick 12 forward, the outdrive nozzle 49 is moved out of alignment with the intake 47 and the pumping unit 48, shown in FIG. 5B, into a position in which the nozzle 49 is preferably angled downward (toward the ground), preferably at between about a 20 and about a 45 degree angle in relation to a longitudinal axis of the watercraft 70. The nozzle 49 is most preferably at about a 45 degree angle, as shown in outline in FIG. 5B, when the joystick 12 is in the forward most position, which is shown in outline in FIG. 5A. Water is forced out of the nozzle 49 in a downward direction, which, in addition to propelling the watercraft forward, propels the stern of the watercraft upward and the bow downward into an optimal planning position. Thus, the driver pushes the joystick 12 forward after starting the boat to get the boat “out of the hole.”

Once the watercraft 70 is generally on plane, the watercraft driver returns the joystick 12 to its upright, generally vertical (steady state) position. When the joystick 12 is in the upright position, water is forced out of the nozzle 49 in a rearward direction, which propels the watercraft forward. Thus, the watercraft driver keeps the joystick 12 in the upright position in order to steer the watercraft straight ahead.

As illustrated in FIG. 5A, the joystick 12 is pivotable between the upright, generally vertical position and the forward position. The trim pivot point 20 of the joystick apparatus 12a is generally perpendicular to the pivot joint 19 and attached to the upper plate 31. In contrast, the joystick mechanical housing 13 is only attached to the joystick steering arm 15 and “floats” within its plate aperture 61. The end rod 76 of the trim control cable 11d is attached to the lower end of the joystick steering arm 15 via a cable connector 77 or any other suitable means of connection. As seen in FIG. 5B, the opposite end of the trim control push-pull cable 11d is attached to a first L-shaped arm 43 via a first pin 41 in an aperture at an end of the L-shaped arm 43. The L-shaped arm 43 is attached to the movable nozzle 49.

In use, when the joystick 12 is pushed forward, the end rod of the trim control cable 11d adjacent the joystick arm 15 is pushed in, which pushes out the end rod on the opposite end of the trim control push-pull cable 11d near the outdrive (see FIGS. 5A and B). The end rod 76 in turn pushes the first L-shaped arm 43 attached to it, which pivots the nozzle 49 downward. When the watercraft is on, strong outflow from the outdrive nozzle 49 causes the stern of the watercraft to lift up, which pushes the bow down.

As seen in FIGS. 2, 3A, and 5A, an end rod 76 of the throttle push-pull cable 11b is attached to a lower end of the throttle trigger portion 16a. As seen in FIG. 7, an end rod 76 at the opposite end of the throttle push-pull cable 11b is attached to the throttle 86, which is a part of the carburetor 89 of the engine 88, or the fuel injection system, which is adjacent to the engine cylinders 85 of the engine 88. The throttle trigger 16 is preferably attached to the joystick 12 by a throttle trigger attachment strap 87, as seen in FIG. 2. When the throttle trigger 16 is squeezed (toward the hand grip 14), the upper cable end rod is pulled out, which pulls in the end rod 76 at the opposite end of the throttle push-pull cable 11b. Full throttle position is indicated by 86b in FIG. 7. When the throttle trigger is not depressed, it returns to the rest position as indicated by 86a in FIG. 7.

The present steering and control apparatus 10 utilizes push-pull cables and does not require other types of cables with pulleys, so the likelihood of problems associated with rust is minimized. Also, cables with pulleys often stretch, causing the system to go out of alignment. The present apparatus with its push-pull cables and no pulleys (or springs) is unlikely to do so.

From the foregoing it can be realized that the described device of the present invention may be easily and conveniently utilized as a steering and control apparatus for a small watercraft. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 steering and control apparatus
11a F/R push-pull cable
11b throttle push-pull cable
11c left/right push-pull cable
11d trim control push-pull cable
12a joystick apparatus
12 joystick
13 joystick mechanical housing
14 hand grip
15 steering arm
16a throttle trigger portion
16 throttle trigger
17 outdrive
18 rubber boot
19 pivot joint
20 trim point pivot
21 first sides
30 well
31 upper plate
32 second sides
33 first bolts
34 second bolts
35 bolt aperture
36 pivot casing
41 first pin through arm aperture
43 first L-shaped arm
49 outdrive nozzle
50 flanges
51 flange bolts
52 flange nuts
53 outdrive bracket
54 outdrive bracket screw
55 pivot pin
56 second L-shaped arm
58 second pin in arm aperture
61 plate aperture
63 watercraft driver
64 watercraft cockpit
65 throttle
66 F/R lever mechanism
67 F/R lever
68 bucket
69 F/R lever slot
70 watercraft
71 lower plate
72 F/R lever hole
73 lever ball
74 deck
75 F/R lever arm
76 cable end rod
77 cable end rod connector
78 generally vertical bracket
79 cable connector
80 bucket bracket
81 bucket bracket screw
82 generally vertical L/R bracket
83 L/R bracket portion
84 threaded pin
85 engine cylinders
86 throttle
87 throttle trigger strap
88 engine
89 engine carburetor
90 mounting fin on lower plate
91 fin hole

What is claimed is:

1. An apparatus for steering and controlling a waterjet propelled small watercraft, the steering and control apparatus comprising:
(a) a joystick apparatus comprising a movable joystick in a cockpit of the watercraft, and a mechanical housing supporting the joystick;
(b) an outdrive at a rear of the watercraft, the outdrive comprising a movable rear nozzle,
(c) a trim control push-pull cable operably connecting the joystick apparatus and the movable nozzle;
(d) a left/right push-pull cable operably connecting the joystick apparatus and the movable nozzle;
(e) a throttle trigger portion attached to the joystick apparatus; and
(f) a forward/reverse push-pull cable linking the throttle trigger portion and a throttle of the watercraft.

2. The steering and control apparatus according to claim 1, further comprising: (g) a forward/reverse lever mechanism adjacent the joystick apparatus; and (h) a forward/reverse push-pull cable operably connecting the forward/reverse mechanism and a mechanism for diverting an outflow from the outdrive nozzle.

3. The steering and control apparatus according to claim 2, wherein the forward/reverse lever mechanism comprises a forward/reverse lever, and the outflow diverting mechanism is movably attached to the outdrive.

4. The steering and control apparatus according to claim 3, wherein the mechanism for diverting the outflow from the outdrive nozzle is a bucket.

5. The steering and control apparatus according to claim 3, wherein the forward/reverse lever mechanism further comprises a forward/reverse lever arm attached to a lower end of the forward/reverse lever below the lower plate, an opposite end of the forward/reverse lever arm being attached to a slidable first end rod of the forward/reverse push-pull cable.

6. The steering and control apparatus according to claim 3, wherein the forward/reverse lever extends through corresponding slotted holes in a generally horizontally extending upper plate attached to a top face of a deck of the watercraft, and a generally horizontally extending lower plate attached to a bottom face of the deck.

7. The steering and control apparatus according to claim 4, wherein the bucket is movably connected to an end rod on the opposite end of the forward/reverse push-pull cable and to the outdrive, so that the bucket is movable over an outflow from the nozzle.

8. The steering and control apparatus according to claim 7, wherein one, threaded end of a cable end rod connector is attached to a correspondingly threaded end of the second cable end rod at the opposite end of the forward/reverse push-pull cable, and an opposite end of the cable end rod connector is attached to an end of a bucket bracket, an opposite end of the bucket bracket being attached to the movable bucket.

9. The steering and control apparatus according to claim 1, wherein the joystick apparatus comprises a joystick steering arm with a hand grip on its upper end portion; a lower end of the joystick steering arm being attached to an end of the left/right push-pull cable and the trim control push-pull cable.

10. The steering and control apparatus according to claim 9, wherein the generally rectangular shaped mechanical housing comprises two opposite first sides and two opposite second sides, which form a central well; the first and second sides of the mechanical housing extending through a generally rectangularly shaped plate aperture in a generally horizontally extending upper plate attached to a top face of a deck of the watercraft.

11. The steering and control apparatus according to claim 10, wherein the first and second sides are not attached to the upper plate; and the generally vertically extending steering arm extends through the well and through a generally horizontally extending pivot joint.

12. The steering and control apparatus according to claim 11, wherein the pivot joint is movably attached to at least two pivot casings resting in corresponding apertures of two opposite sides of the joystick mechanical housing.

13. The steering and control apparatus according to claim 9, wherein the throttle trigger mechanism comprising a throttle trigger extending in an upward direction adjacent the joystick hand grip, the throttle trigger being attached to the joystick steering arm adjacent the hand grip.

14. The steering and control apparatus according to claim 9, wherein an opposite end rod of the trim control push-pull cable is attached to a first L-shaped arm, a portion of the first L-shaped arm being attached to the movable outdrive nozzle.

15. The steering and control apparatus according to claim 1, wherein an opposite end rod of the left/right push-pull cable is attached to a second L-shaped arm, a portion of the second L-shaped arm being attached to the movable outdrive nozzle.

16. The steering and control apparatus according to claim 14, wherein movement of the joystick from a generally vertical position to a forward position causes the nozzle to be angled downward, which propels the stem of the watercraft in a generally upward direction.

17. The steering and control apparatus according to claim 14, wherein the joystick apparatus further comprises a trim pivot point generally perpendicular to the pivot joint, the trim pivot point being attached to the upper plate.

18. The steering and control apparatus according to claim 15, wherein movement of the joystick in a left or right direction causes movement of the nozzle in an opposite direction, and subsequent movement of the watercraft in the same direction as the joystick movement.

19. The steering and control apparatus according to claim 1, wherein an end rod of the throttle push-pull cable is attached to a lower end of the throttle trigger; an end rod at the opposite end of the throttle push-pull cable being attached to the throttle of an engine of the watercraft.
